(19) United States
(12) Patent Application Publication
(10) Pub. No.: US 2023/0187647 A1
(43) Pub. Date: Jun. 15, 2023

(54) METHOD OF MAKING POROUS IONICALLY AND ELECTRONICALLY CONDUCTIVE MATRIX FOR ALL SOLID STATE LITHIUM BATTERIES

(71) Applicant: HYZON MOTORS INC., Honeoye Falls, NY (US)

(72) Inventors: Zhijun Gu, Naperville, IL (US); Rajesh Bashyam, Delta, CA (US)

(21) Appl. No.: 18/075,100

(22) Filed: Dec. 5, 2022

Related U.S. Application Data
(60) Provisional application No. 63/289,205, filed on Dec. 14, 2021.

(51) Int. Cl. H01M 4/62; H01M 10/052; H01M 10/0565; H01M 4/48; H01M 10/0587

(52) U.S. Cl. CPC H01M 4/625; H01M 10/052; H01M 10/0565; H01M 4/48; H01M 10/0587; H01M 2300/0082

(57) ABSTRACT

A porous ionically and electronically conductive matrix for all solid-state lithium batteries is deposited on a carbon fiber paper. The ionically and electronically conductive matrix can be deposited on the carbon fiber paper by one of electrospinning and without electrospinning for electrode coating and deposition. The matrix facilitates a loading of active material of a cathode electrode structure.

### CROSS-REFERENCE TO RELATED APPLICATIONS

This application claims the benefit of U.S. Provisional Application No. 63/289,205, filed on Dec. 14, 2021. The entire disclosure of the above application is hereby incorporated herein by reference.

### FIELD

The present technology includes articles of manufacture and processes that relate to solid-state lithium-ion batteries, including ways of making and using a porous ionically and electronically conductive matrix in all solid-state lithium batteries.

### INTRODUCTION

This section provides background information related to the present disclosure which is not necessarily prior art.

All solid-state batteries are gaining significant attention in lithium-ion battery development due to several advantages, including consistent operation, high energy density, and faster charging properties. However, certain challenges remain to be overcome, especially with respect to solid-state electrolytes, in order to improve conductivity and suppress formation of lithium dendrites. Two main approaches are being employed to develop solid electrolytes, the first being the use of inorganic ceramic solid electrolytes and the second being the use of a solid polymer electrolyte, where both approaches have their own advantages and disadvantages.

Advantages of all solid-state lithium-ion batteries include high energy density and safety. However, while expectations for solid-state batteries are high, there are still issues related to materials, processing, and engineering to overcome. To increase the energy density of solid-state batteries, the cathode electrode loading and thickness needs to be substantially increased, while this can come with a significant trade-off in the utilization of active materials. What is more, optimized particle size distribution of the active materials in the electrode is needed to achieve good performance, good electrolyte utilization, and cycling stability in solid-state based batteries. Currently, in most cases, the cathode active material loading in the electrode is between two and five milligrams per square centimeter to minimize the trade off in utilization efficiency; however, such loading may not provide performance viable for commercial vehicular battery applications.

Accordingly, there is a need to increase the lithium-ion transport and conductivity in a relatively thick cathode electrode and minimize the trade off in performance.

### SUMMARY

In concordance with the instant disclosure, a porous ionically and electronically conductive matrix for all solid-state lithium batteries that increases the lithium-ion transport and conductivity in a thick electrode, thereby minimizing a trade off in performance, is surprisingly discovered.

A porous ionically and electronically conductive matrix for a solid-state lithium battery is provided that includes a first layer having a solid electrolyte. A second layer includes a cathode active material, a first lithiated fiber, and a carbon fiber. A third layer includes a carbon paper and a second lithiated fiber, where the second layer is disposed between the first layer and the third layer. Solid-state lithium batteries using the porous ionically and electronically conductive matrix can find particular application in battery powered, fuel cell powered, and hybrid powered vehicles including trucks, buses, and passenger vehicles.

A method of making a porous ionically and electronically conductive matrix for a solid-state lithium battery is provided that includes the following aspects. A mixture is formed that includes a cathode active material, a carbon fiber, and a first lithiated fiber. The mixture is applied to a layer including a carbon paper and a second lithiated fiber. A layer including a solid electrolyte is disposed adjacent the applied mixture.

Further aspects include a porous ionically and electronically conductive matrix for all solid-state lithium batteries deposited on a carbon fiber paper. The ionically and electronically conductive matrix can be deposited on the carbon fiber paper by electrospinning, for example, for electrode coating and deposition. In this way, the porous ionically and electronically conductive matrix facilitates a loading of active material of a cathode electrode structure. Various electrode structures for solid-state batteries can be made according to the present technology. Likewise, various solid-state batteries can include or be manufactured using a porous matrix with an ionically and electronically conductive network provided by the present technology.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic cross-sectional design of an embodiment of a porous ionically and electronically conductive matrix for all solid-state lithium batteries, in accordance with the present technology;

FIG. 2 is a schematic cross-sectional design of another embodiment of a porous ionically and electronically conductive matrix for all solid-state lithium batteries, in accordance with the present technology;

FIG. 3 is a schematic cross-sectional design of yet another embodiment of a porous ionically and electronically conductive matrix for all solid-state lithium batteries, in accordance with the present technology; and

FIG. 4 is a schematic flowchart of a method of making a porous ionically and electronically conductive matrix for a solid-state lithium battery, in accordance with the present technology.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology relates to increasing lithium-ion transport and increasing conductivity in an electrode for a solid-state lithium battery and addressing challenges associated with cathode electrode design and processing within a solid-state lithium-ion battery. Controlling a positive or cathode electrode structure can be an important aspect for high-performance solid-state batteries. In accordance with the present technology, a porous matrix with an ionically and an electronically conductive network can be created on carbon fiber paper, with or without electrospinning for active material electrode coating or deposition. The present technology can enable the porous matrix to load more active material and improve the utilization of the active material across a thickness of the electrode. The resulting porous matrix is both ionically and electronically conductive.

A porous ionically and electronically conductive matrix for a solid-state lithium battery is provided that includes a first layer, a second layer, and a third layer, where the second layer is disposed between the first layer and the third layer. The first layer includes a solid electrolyte. The second layer includes a cathode active material, a carbon fiber, and a first lithiated fiber. The third layer includes a carbon paper and a second lithiated fiber. The first lithiated fiber and the second lithiated fiber can be the same material, different materials, or mixtures of the same and different materials.

The solid electrolyte of the first layer can include the following aspects. The solid electrolyte can include a lithiated compound. The compound can include one or more various anionic groups that can associate with one or more lithium ions to form the lithiated compound. Certain embodiments of the lithiated compound include a lithiated perfluorosulfonic acid. Examples of lithiated perfluorosulfonic acids include one or more lithiated versions of trifluoromethanesulfonic acid, perfluoroethanesulfonic acid, perfluoropropaneesulfonic acid, perfluorobutanesulfonic acid, perfluoropentanesulfonic acid, perfluorohexanesulfonic acid, perfluoroheptanesulfonic acid, perfluorooctanesulfonic acid, perfluorononanesulfonic acid, and perfluorodecanesulfonic acid. Certain embodiments include where the lithiated compound includes a lithiated perfluorosulfonic acid ion-exchange membrane. The lithiated perfluorosulfonic acid ion-exchange membrane can have an equivalent weight of 300 to 1,100.

The cathode active material of the second layer can include the following aspects. The cathode active material can include a metal oxide and/or a metal phosphate. The metal oxide can include one or more of cobalt oxide, iron oxide, manganese oxide, and nickel oxide. The metal phosphate can include one or more of cobalt phosphate, iron phosphate, manganese phosphate, and nickel phosphate.

The carbon fiber of the second layer can include the following aspects. The carbon fiber can include one or more of carbon microfibers, carbon nanofibers, carbon nanotubes, graphite nanofibers, and graphene. The carbon fiber can have lengths and diameters on the nanometer scale (e.g., 1-100 nanometers) and the micrometer scale (e.g., 1-100 micrometers). The carbon fiber can include formed from precursor polymers that are heat treated to leave carbon atoms bonded together. The carbon fiber can also include vapor grown carbon fibers.

The first lithiated fiber of the second layer can include the following aspects. The first lithiated fiber can be configured as a nanofiber, having lengths and diameters on the nanometer scale. The first lithiated fiber can include a lithiated compound, where the lithiated compound can include one or more lithiated perfluorosulfonic acids. Examples of lithiated perfluorosulfonic acids include one or more lithiated versions of trifluoromethanesulfonic acid, perfluoroethanesulfonic acid, perfluoropropaneesulfonic acid, perfluorobutanesulfonic acid, perfluoropentanesulfonic acid, perfluorohexanesulfonic acid, perfluoroheptanesulfonic acid, perfluorooctanesulfonic acid, perfluorononanesulfonic acid, and perfluorodecanesulfonic acid. The lithiated compound can be associated with various types of fibers to form the first lithiated fiber. Examples of fibers include carbon fiber, which can include one or more of carbon microfibers, carbon nanofibers, carbon nanotubes, graphite nanofibers, and graphene.

The carbon paper of the third layer can include the following aspects. The carbon paper can be formed of carbon microfibers. The carbon paper can therefore be porous, where it is formed of carbon microfibers manufactured into a flat sheet. Carbon paper formed in this manner can be microporous, including a homogeneous distribution of micropores throughout the carbon paper.

The second lithiated fiber of the third layer can include the following aspects. The second lithiated fiber can be configured as a nanofiber, having lengths and diameters on the nanometer scale. The second lithiated fiber can include a lithiated compound, where the lithiated compound can include one or more lithiated perfluorosulfonic acids. Examples of lithiated perfluorosulfonic acids include one or more lithiated versions of trifluoromethanesulfonic acid, perfluoroethanesulfonic acid, perfluoropropaneesulfonic acid, perfluorobutanesulfonic acid, perfluoropentanesulfonic acid, perfluorohexanesulfonic acid, perfluoroheptanesulfonic acid, perfluorooctanesulfonic acid, perfluorononanesulfonic acid, and perfluorodecanesulfonic acid. The lithiated compound can be associated with various types of fibers to form the second lithiated fiber. Examples of fibers include carbon fiber, which can include one or more of carbon microfibers, carbon nanofibers, carbon nanotubes, graphite nanofibers, and graphene. The first lithiated fiber and the second lithiated fiber can be the same material, different materials, or mixtures of the same and different materials.

The porous ionically and electronically conductive matrix can further include the following aspects. A fourth layer can be provided adjacent the first layer and opposite the second layer, where the fourth layer includes a metal layer. The metal layer can include a lithium layer. The metal layer can further include a copper layer, where the lithium layer is adjacent the first layer. The lithium layer can be directly adjacent the first layer. A fifth layer can be provided adjacent the third layer and opposite the second layer, where the fifth layer can include a metal layer. The metal layer of the fifth layer can include an aluminum layer. It is further possible to have an ionically and electronically conductive adhesive layer disposed between the fifth layer and the third layer. In this way, the adhesive layer can couple the fifth layer to the third layer.

The present technology further contemplates various constructs and devices incorporating the porous ionically and electronically conductive matrix. In particular, various types of solid-state lithium batteries can include various configurations of the porous ionically and electronically conductive matrix. Examples include where the layers of the porous ionically and electronically conductive matrix are curved, bent, rolled (e.g., Archimedean spiral), folded, or otherwise configured for assembly into a predetermined battery cell shape, such as various polyhedral battery cells, cylindrical battery cells, coin battery cells, and flat or pouch battery cells. Batteries can also include configurations of multiple electrically connected cells.

Solid-state lithium batteries including the porous ionically and electronically conductive matrix can be used in various applications. Examples include various consumer electronic devices, energy storage applications, and transportation applications. Solid-state lithium batteries using the porous ionically and electronically conductive matrix can find particular application in battery powered, fuel cell powered, and hybrid powered vehicles including trucks, buses, and passenger vehicles.

Ways of making a porous ionically and electronically conductive matrix for a solid-state lithium battery are also provided by the present technology. These include formation of a mixture including a cathode active material, a carbon fiber, and a first lithiated fiber. The mixture can be applied to a layer including a carbon paper and a second lithiated fiber. A layer including a solid electrolyte can be disposed adjacent the applied mixture, thereby making the porous ionically and electronically conductive matrix for a solid-state lithium battery, having: a first layer including the solid electrolyte; a second layer including the cathode active material, the carbon fiber, and the first lithiated fiber; and a third layer including the carbon paper and the second lithiated fiber; wherein the second layer is disposed between the first layer and the third layer. Certain embodiments include where the mixture is applied to the layer including the carbon paper and the second lithiated fiber by electrospinning the mixture.

Ways of making a porous ionically and electronically conductive matrix can further include the following aspects. A fourth layer can be disposed adjacent the first layer and opposite the second layer, where the fourth layer includes a first metal layer. A fifth layer can be disposed adjacent the third layer and opposite the second layer, where the fifth layer includes a second metal layer. An ionically and electronically conductive adhesive layer can also be applied to one of the fifth layer and the third layer prior to disposing the fifth layer adjacent the third layer and opposite the second layer.

The porous ionically and electronically conductive matrix provided by the present technology can provide certain benefits and advantages in lithium-ion solid-state batteries, including batteries used for various portable and mobility applications such as vehicles. Several issues with respect to optimization of lithium-ion batteries are addressed by the present technology, including increasing lithium-ion transport and conductivity in the electrode, and further improving cathode electrode design and processing. In particular, the present technology can improve the utilization of the active material across a thickness of the electrode, as the porous matrix facilitates an increased loading of the active material.

### EXAMPLES

Example embodiments of the present technology are provided with reference to the several figures enclosed herewith.

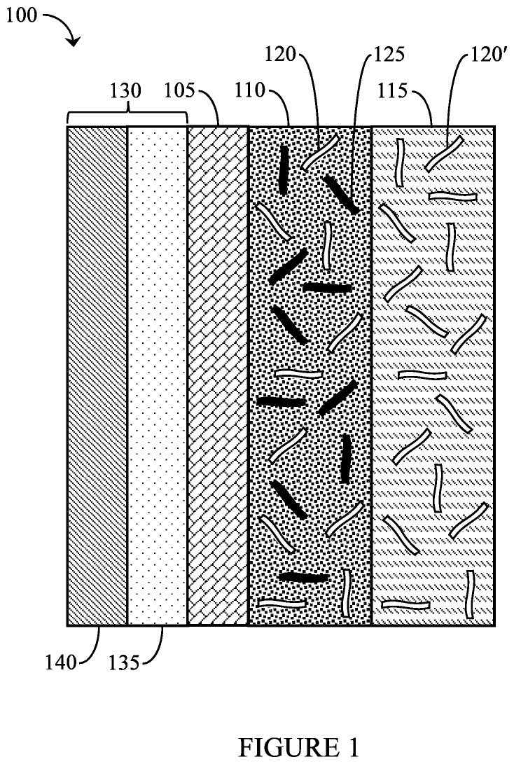

With reference to FIG. 1, a first embodiment of a porous ionically and electronically conductive matrix is shown at 100. A first layer 105 includes a solid electrolyte; e.g., a lithiated compound. A second layer 110 includes a cathode active material; e.g., a metal oxide and/or a metal phosphate. A third layer 115 includes a carbon paper; e.g., carbon microfibers. A first lithiated fiber 120 is included in the second layer 110 and a second lithiated fiber 120′ is included in the third layer 115. The first lithiated fiber 120 and the second lithiated fiber 120′ can be the same material. The second layer 110 also includes a carbon fiber 125. As shown, the second layer 110 is disposed between the first layer 105 and the third layer 115.

The first lithiated fiber 120 and the second lithiated fiber 120′ can be integrated or embedded into the second layer 110 including the cathode active material and the third layer 115 including the carbon paper, respectively. The carbon fiber 125 can be integrated or embedded into the second layer 110 including the cathode active material. The second layer 110 can directly contact the first layer 105 and can directly contact the third layer 115.

A fourth layer 130 is provided that includes a metal layer. The fourth layer 130 is disposed adjacent the first layer 105 and opposite the second layer 110. In this way, the first layer 105 can directly contact the second layer 110 and the fourth layer 130. In the embodiment shown, the metal layer of the fourth layer 130 can include a lithium layer 135 and a copper layer 140, where the lithium layer 135 is disposed adjacent the first layer 105. In this way, the lithium layer 135 can directly contact the first layer 105 including the solid electrolyte.

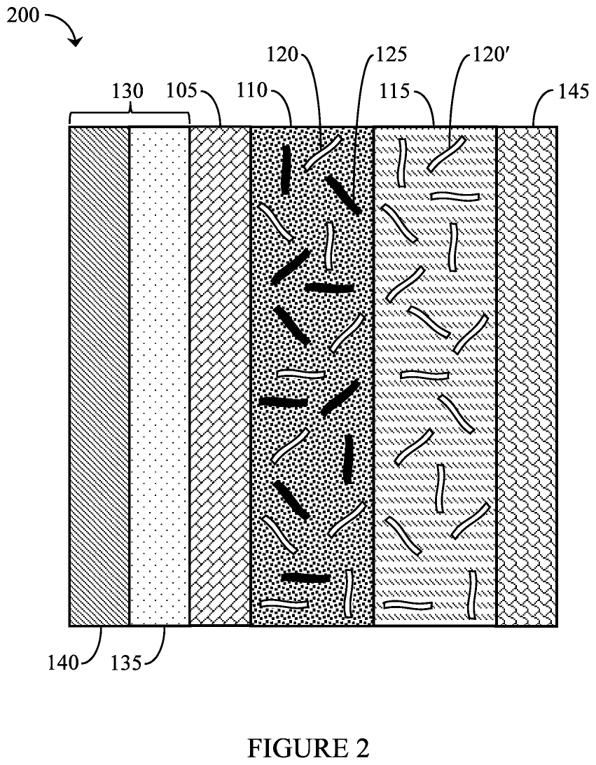

With reference to FIG. 2, a second embodiment of a porous ionically and electronically conductive matrix is shown at 200, which further includes a fifth layer 145 including a metal layer; e.g., an aluminum layer. The fifth layer 145 is disposed adjacent the third layer 115 and opposite the second layer 110. In this way, the third layer 115 can directly contact the second layer 110 and the fifth layer 145.

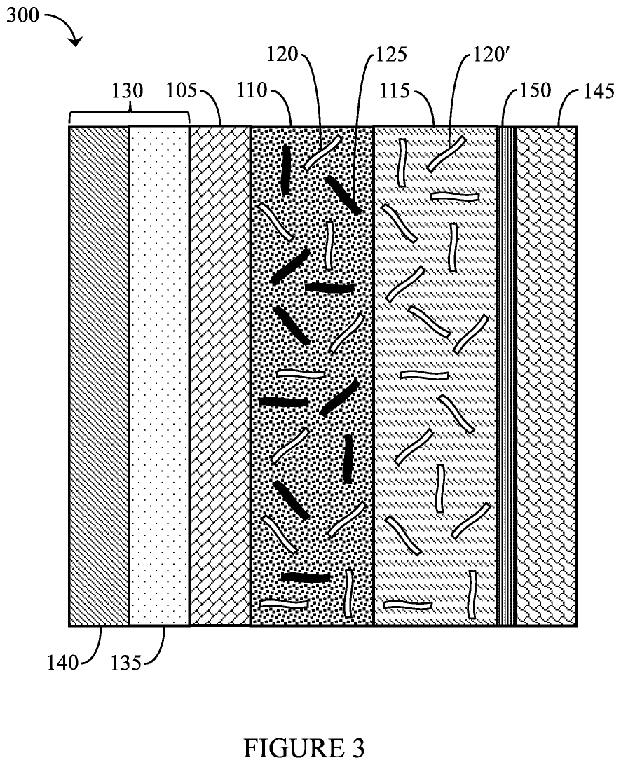

With reference to FIG. 3, a third embodiment of a porous ionically and electronically conductive matrix is shown at 300, which further includes an ionically and electronically conductive adhesive layer 150. The ionically and electronically conductive adhesive layer 150 is disposed between the third layer 115 and the fifth layer 145. In this way, the ionically and electronically conductive adhesive layer 150 can directly contact the third layer 115 and the fifth layer 145.

It should be appreciated that while the embodiments shown in FIGS. 1-3 are depicted as having generally parallel layers, it is understood that the porous ionically and electronically conductive matrix can be configured in various ways to form various lithium battery architectures. Examples include where the respective layers are curved, bent, rolled (e.g., Archimedean spiral), folded, or otherwise configured for assembly into a predetermined battery cell shape, such as various polyhedral battery cells, cylindrical battery cells, coin battery cells, and flat or pouch battery cells. Batteries can also include multiple electrically connected cells.

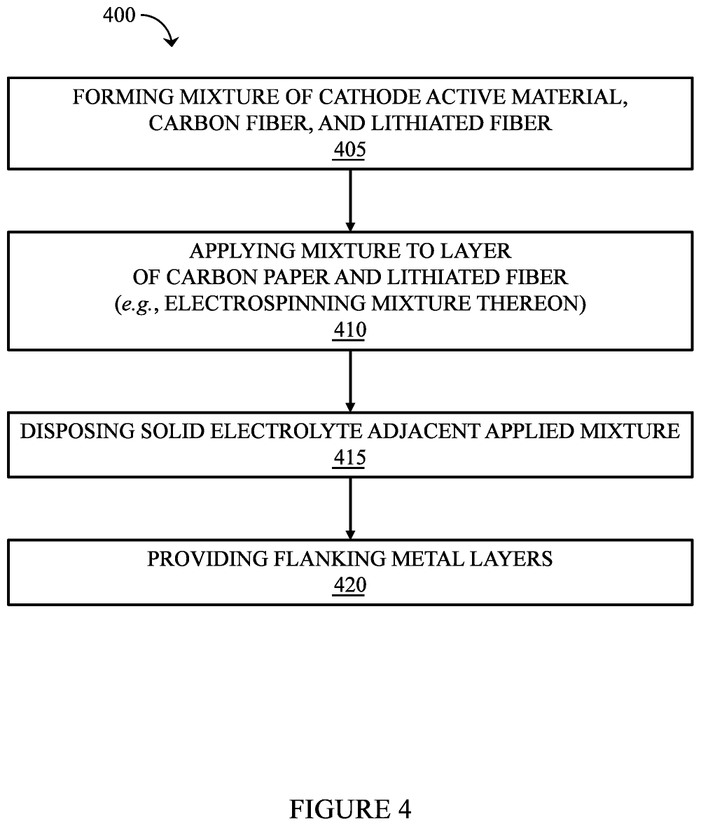

With reference to FIG. 4, an embodiment of a method of making a porous ionically and electronically conductive matrix is shown at 400. Step 405 includes forming a mixture including a cathode active material, a carbon fiber, and a first lithiated fiber. This is followed by step 410 that includes applying (e.g., electrospinning) the mixture to a layer including a carbon paper and a second lithiated fiber. Step 415 then requires disposing a layer including a solid electrolyte adjacent the applied mixture. In this way, the porous ionically and electronically conductive matrix for a solid-state lithium battery, having: a first layer including the solid electrolyte; a second layer including the cathode active material, the carbon fiber, and the first lithiated fiber; and a third layer including the carbon paper and the second lithiated fiber, wherein the second layer is disposed between the first layer and the third layer. Step 420 can then provide flanking metal layers such as the fourth layer and the fifth layer.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A porous ionically and electronically conductive matrix for a solid-state lithium battery, comprising:
a first layer including a solid electrolyte;
a second layer including a cathode active material, a first lithiated fiber, and a carbon fiber; and
a third layer including a carbon paper and a second lithiated fiber;
wherein the second layer is disposed between the first layer and the third layer.

2. The porous ionically and electronically conductive matrix for a solid-state lithium battery of claim 1, wherein the solid electrolyte includes a lithiated compound.

3. The porous ionically and electronically conductive matrix for a solid-state lithium battery of claim 2, wherein the lithiated compound includes a lithiated perfluorosulfonic acid.

4. The porous ionically and electronically conductive matrix for a solid-state lithium battery of claim 1, wherein the cathode active material includes one of a metal oxide and a metal phosphate.

5. The porous ionically and electronically conductive matrix for a solid-state lithium battery of claim 4, wherein the cathode active material includes the metal oxide and the metal oxide includes a member selected from a group consisting of cobalt oxide, iron oxide, manganese oxide, and nickel oxide.

6. The porous ionically and electronically conductive matrix for a solid-state lithium battery of claim 4, wherein cathode active material includes the metal phosphate and the metal phosphate includes a member selected from a group consisting of cobalt phosphate, iron phosphate, manganese phosphate, and nickel phosphate.

7. The porous ionically and electronically conductive matrix for a solid-state lithium battery of claim 1, wherein the carbon fiber includes a member selected from a group consisting of carbon microfibers, carbon nanofibers, carbon nanotubes, graphite nanofibers, and graphene.

8. The porous ionically and electronically conductive matrix for a solid-state lithium battery of claim 1, wherein one of the first lithiated fiber and the second lithiated fiber includes a lithiated compound.

9. The porous ionically and electronically conductive matrix for a solid-state lithium battery of claim 8, wherein the lithiated compound includes a lithiated perfluorosulfonic acid.

10. The porous ionically and electronically conductive matrix for a solid-state lithium battery of claim 1, further comprising a fourth layer adjacent the first layer and opposite the second layer, the fourth layer including a metal layer.

11. The porous ionically and electronically conductive matrix for a solid-state lithium battery of claim 10, wherein the metal layer includes a lithium layer.

12. The porous ionically and electronically conductive matrix for a solid-state lithium battery of claim 11, wherein the metal layer further includes a copper layer, and the lithium layer is adjacent the first layer.

13. The porous ionically and electronically conductive matrix for a solid-state lithium battery of claim 1, further comprising a fifth layer adjacent the third layer and opposite the second layer, the fifth layer including a metal layer.

14. The porous ionically and electronically conductive matrix for a solid-state lithium battery of claim 13, wherein the metal layer includes an aluminum layer.

15. The porous ionically and electronically conductive matrix for a solid-state lithium battery of claim 13, further comprising an ionically and electronically conductive adhesive layer disposed between the third layer and the fifth layer.

16. A solid-state lithium battery comprising the porous ionically and electronically conductive matrix of claim 1.

17. A method of making a porous ionically and electronically conductive matrix for a solid-state lithium battery, comprising:
forming a mixture including a cathode active material, a carbon fiber, and a first lithiated fiber;
applying the mixture to a layer including a carbon paper and a second lithiated fiber; and
disposing a layer including a solid electrolyte adjacent the applied mixture;
thereby making the porous ionically and electronically conductive matrix for a solid-state lithium battery, having:
a first layer including the solid electrolyte;
a second layer including the cathode active material, the carbon fiber, and the first lithiated fiber; and
a third layer including the carbon paper and the second lithiated fiber;
wherein the second layer is disposed between the first layer and the third layer.

18. The method of claim 17, wherein applying the mixture to the layer including the carbon paper and the second lithiated fiber includes electrospinning the mixture.

19. The method of claim 17, further comprising:
disposing a fourth layer adjacent the first layer and opposite the second layer, the fourth layer including a first metal layer; and
disposing a fifth layer adjacent the third layer and opposite the second layer, the fifth layer including a second metal layer.

20. The method of claim 19, further comprising applying an ionically and electronically conductive adhesive layer to one of the fifth layer and the third layer prior to disposing the fifth layer adjacent the third layer and opposite the second layer.
